(19) United States
(12) Patent Application Publication
(10) Pub. No.: US 2021/0307997 A1
(43) Pub. Date: Oct. 7, 2021

(54) APPARATUS FOR THE PHYSICAL TRAINING OF AT LEAST ONE OF THE LIMBS OF A LIVING BEING

(71) Applicant: MAD-UP, ANGERS (FR)

(72) Inventor: Delis AHOU, BOUCHEMAINE (FR)

(21) Appl. No.: 17/265,355

(22) PCT Filed: Jul. 31, 2019
(86) PCT No.: PCT/FR2019/051878

§ 371 Date: Feb. 2, 2021

(30) Foreign Application Priority Data
Aug. 6, 2018 (FR) 1857323

(51) Int. Cl. A61H 9/00

(52) U.S. Cl. CPC A61H 9/0092; A61H 2209/00; A61H 2201/5071

(57) ABSTRACT

Apparatus (1) for the physical training of at least one of the limbs (40) of a living being, comprising a cuff (2) comprising an inflatable pouch (3), a device (4) for inflating the pouch (3), a system (5) for venting the pouch (3), a control unit (9) controlling the inflation device (4), said inflatable pouch (3) and the cuff (2) surrounding the pouch (3) being able to be positioned around a limb (40) that is to be trained so as to make it possible, when the pouch (3) is in the inflated state, to reduce the blood circulation through said limb (40). The training apparatus (1) comprises an air reserve (6) connected to the pouch (3) for transfer of air between the pouch (3) and the air reserve (6) at least when the pouch is deformed, and a pressure sensor (7) configured to measure the pressure of the air circuit, at least part of which is formed by the fluidic connection (8) between the inflatable pouch (3) and the air reserve (6).

The invention relates to an apparatus for the physical training of at least one of the limbs of a living being.

It relates more particularly to a physical training apparatus comprising at least one cuff comprising an inflatable pouch, an inflation device for inflating the pouch, a system for venting the inflatable pouch, a control unit configured to control at least the inflation device, said inflatable pouch and the cuff surrounding the pouch being able to be positioned around a limb that is to be trained and being configured to permit, in the inflated state of the pouch, by compression, in particular by constriction, of the limb, a reduction in the blood flow through said limb by at least partial occlusion of the blood circulation system.

It is known that, in order to maintain or develop muscles, it is necessary to perform physical exercises to tire the muscles, this muscular fatigue eliciting a number of physiological responses, such as the stimulation of growth hormone, which can lead in the long term to muscle development. However, such a result can be obtained only after a great number of physical exercises, which takes time, and which requires significant physical expenditure that may be detrimental in particular to the joints. Based on this principle, physical training apparatuses capable of artificially recreating the conditions of muscle fatigue have been conceived. These apparatuses are based on the following observations:
by compressing a limb at a suitable pressure with the aid of a cuff comprising an inflatable pouch, the pouch being interposed between the cuff and the limb, the blood flow, in particular the venous flow, through the limb is reduced,
by maintaining these conditions of restricted blood flow through the limb for a certain time, the same conditions are recreated that are experienced by a limb that has been subjected to intense physical exercise. It therefore becomes possible, with reduced exercise time, to obtain effects similar to those that are obtained by performing intensive physical activity.

However, these apparatuses have not been widely developed, due in particular to the fact that the physical exercises performed using such apparatuses are unsafe and painful. In addition, if used improperly, such apparatuses cause thromboses, among other things. In order to increase the efficiency of such apparatuses, it is advisable to work as close as possible to the venous return occlusion pressure without ever reaching the minimum arterial occlusion pressure, also called the systolic pressure. However, the current design of most of the apparatuses does not allow for such precision. Furthermore, due to the current design of the apparatuses, it is often necessary, throughout the entire duration of the exercise, to successively inflate and deflate the pouch, the inflation taking place during the phase of muscle relaxation, and the deflation taking place during the phase of muscle contraction, which leads to considerable noise being caused by the operation of the pump.

An object of the invention is to make available a physical training apparatus of the aforementioned type whose design makes it possible to maintain the inflation pressure of the pouch, corresponding to the working pressure, as constant as possible, and therefore closest to the optimal value in relation to the minimum arterial or venous occlusion pressure.

Another object of the invention is to make available a physical training apparatus of the aforementioned type whose design does not necessitate inflation and deflation of the pouch with each movement, without adversely impacting the quality of the work performed.

To this end, the invention relates to an apparatus for the physical training of at least one of the limbs of a living being, said apparatus comprising at least one cuff comprising an inflatable pouch, an inflation device for inflating the pouch, a system for venting the inflatable pouch, a control unit configured to control at least the inflation device, said inflatable pouch and the cuff surrounding the pouch being able to be positioned around a limb that is to be trained and being configured to permit, in the inflated state of the pouch, by compression, in particular by constriction, of the limb, a reduction in the blood flow through said limb by at least partial occlusion of the blood circulation system, characterized in that the training apparatus comprises an air reserve connected to the inflatable pouch by a fluidic connection for transfer of air between the pouch and the air reserve at least upon a deformation of the pouch resulting from a muscle activity, in particular a relaxation or a contraction of the limb fitted with the cuff, and a pressure sensor configured to measure the pressure of the air circuit, at least part of which is formed by the fluidic connection between the inflatable pouch and the air reserve.

The presence of an air reserve in communication with the inflatable pouch of the cuff allows a free transfer of a volume of air between the inflatable pouch and the air reserve during an exercise. The volumes of the air reserve and of the inflatable pouch form between them a closed circuit for maintaining the working pressure as defined initially. The transfer of the air from the inflatable pouch to the air reserve takes place during a deformation of the pouch in the sense of a contraction of the pouch, this contraction possibly resulting in particular from a contraction of the muscle that the pouch surrounds, while the transfer of the air from the air reserve to the inflatable pouch takes place during a deformation of the pouch in the sense of an expansion of the pouch, this expansion being able to take place during the relaxation of the muscle that the pouch surrounds. These air transfer phases take place with a constant quantity of air. The air transfer takes place without energy consumption or pump noise.

By virtue of the presence of the air reserve, the apparatus works at a perfectly controlled working pressure, with a guarantee of working as close as possible to the venous return occlusion pressure, without ever reaching the arterial occlusion pressure. The resulting muscular work is therefore more efficient. It takes place completely safely, that is to say with reduced risk of thrombosis, and in comfort, since the pain is reduced.

According to one embodiment of the invention, the venting system comprises a member for venting the inflatable pouch, said member preferably being arranged on the air reserve, and the control unit is configured to control the member for venting the inflatable pouch. The venting system allows the pouch to be deflated after each training session, but it can also constitute a safety device used in exceptional conditions. Due to the presence of the air reserve, this venting system no longer has to be controlled with each movement.

According to one embodiment of the invention, the pressure sensor is arranged at the level of the fluidic connection between the inflatable pouch and the air reserve.

This results in increased sensitivity of the pressure sensor. In addition, this arrangement makes the pressure sensor more versatile.

According to one embodiment of the invention, the fluidic connection between the air reserve and the inflatable pouch is formed by a flexible conduit, and the pressure sensor is preferably a membrane sensor.

According to one embodiment of the invention, the volume of the air reserve is greater than the volume of the inflatable pouch. The greater the volume of the air reserve compared to the air volume of the inflatable pouch, the more the comfort is increased.

According to one embodiment of the invention, the apparatus comprises a memory for memorizing at least one pressure setpoint called the working pressure, corresponding to a pressure lower than the systolic pressure or arterial occlusion pressure of the artery surrounded by the limb, and the control unit is configured to control at least the inflation device and the venting system according to the working pressure setpoint and the data supplied by the pressure sensor.

According to one embodiment of the invention, the control unit is configured, in the configuration of use of the apparatus for physical training, to maintain the pressure measured by the pressure sensor within a predetermined pressure range containing the working pressure setpoint. Thus, a variation of the working pressure within a predefined range is authorized. The drop in the working pressure to a value below the minimum pressure value of the pressure range causes the pouch to inflate so that the pressure returns to within the predetermined pressure range, while an increase in the working pressure to a value greater than the maximum pressure value of the pressure range causes the pouch to be vented. This drop and this increase should take place only in exceptional circumstances.

According to one embodiment of the invention, the control unit is configured to control the inflation device according to an operating protocol comprising an operating cycle or a plurality of operating cycles that are activated sequentially, each operating cycle comprising filling the pouch and the air reserve with air up to the working pressure setpoint value, maintaining the pouch in the inflated state for a fixed or variable duration, and deflating the pouch.

This period of maintaining the pouch in the inflated state can be fixed, or it can be variable, for example, depending on the choice made by the user or on a pre-recorded muscle exercise control program.

According to one embodiment of the invention, in the inflated state of the pouch, the control unit is configured to receive the pressure signals coming from the pressure sensor, to determine from the pressure curve, measured by the pressure sensor as a function of time, the number of muscle relaxations and/or muscle contractions of the muscle of the limb that is to be trained, to compare this number to a predetermined number, and to control the deflation of the pouch when the number counted is greater than the number measured. The apparatus thus makes it possible, during physical exercise, to count the number of movements made and to stop the exercise by deflating the pouch when the number of movements to be performed is reached.

According to one embodiment of the invention, the working pressure setpoint is a calculated setpoint, and the control unit is configured to
control the inflation of the inflatable pouch in stages,
acquire, at each pressure stage, the pressure signals coming from the pressure sensor,
determine, for each pressure stage, the value of a characteristic parameter of the pressure curve as a function time, called the pulse wave curve,
and determine the value of the working pressure setpoint as a function of the values of said parameters. This value of the working pressure setpoint is chosen to be lower than the occlusion pressure, which corresponds to a value where the amplitude of the pulse wave is 0, but as close as possible to this occlusion pressure value.

According to one embodiment, the inflation device comprises a pump or a compressor.

According to one embodiment, the inflation device is coupled to the air reserve in order to supply air to the air reserve, which itself communicates with the inflatable pouch via the fluidic connection. Thus, the inflatable pouch is supplied by the inflation device via the air reserve.

The invention will be clearly understood on reading the following description of illustrative embodiments, with reference to the appended drawings, in which:

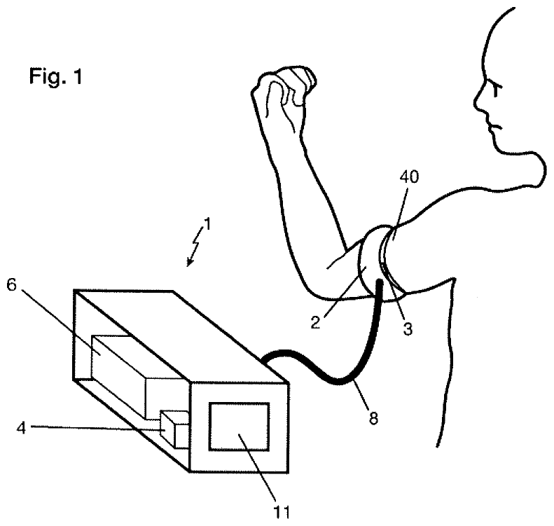

FIG. 1 shows an overall perspective view of a physical training apparatus according to the invention in the use configuration, that is to say in the state with the cuff placed around a limb of a wearer, and in the inflated state of the pouch,

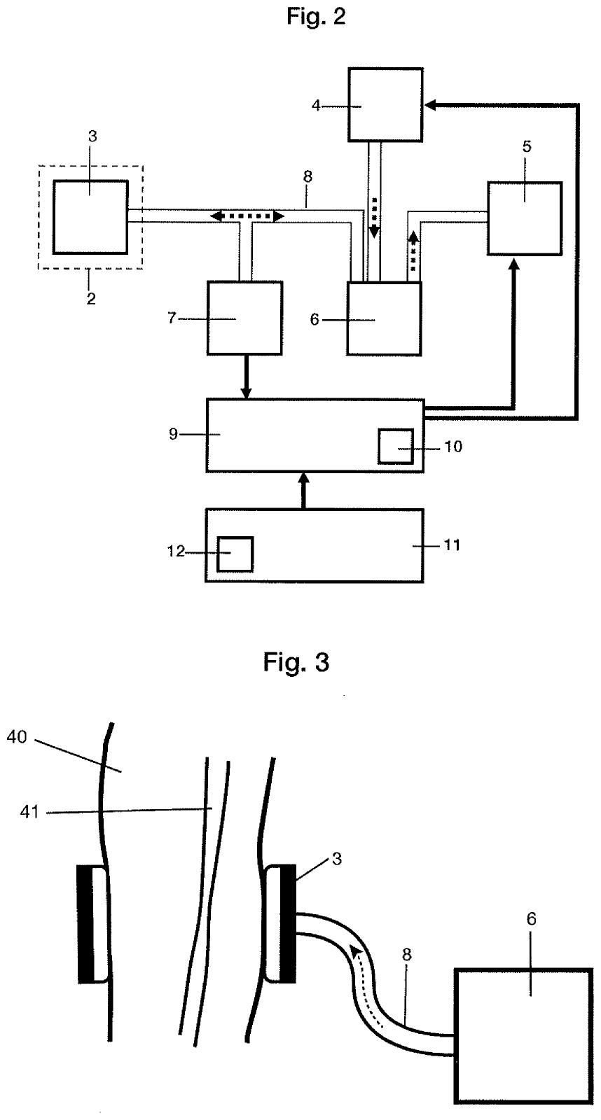

FIG. 2 shows a schematic view of an apparatus according to the invention,

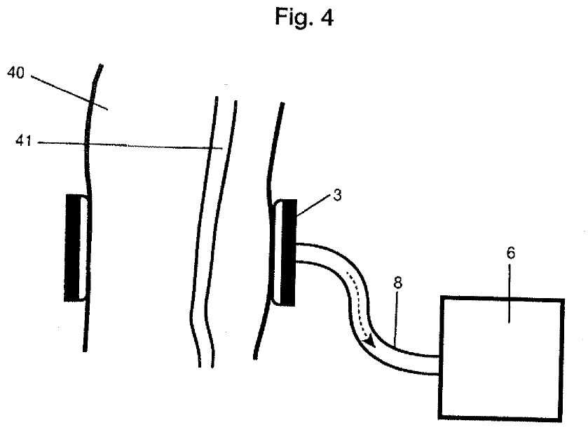

FIGS. 3 and 4 show, in the form of schematic views, the transfer of air between the air reserve and the inflatable pouch during the cardiac phases of diastole (FIG. 3) and systole (FIG. 4), the limb fitted with the apparatus being at rest,

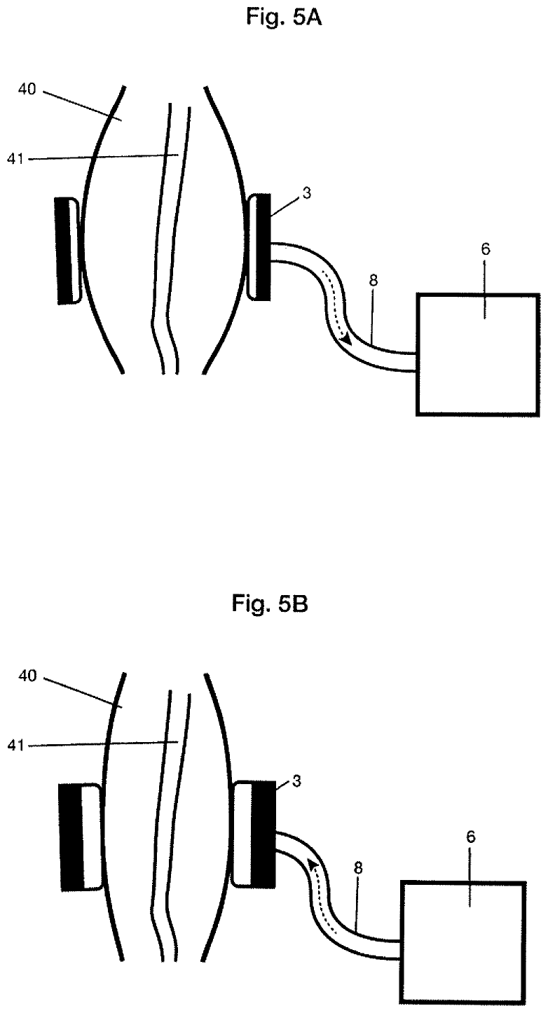

FIGS. 5A and 5B show, in the form of schematic views, during muscular exercise of the limb fitted with the apparatus, the transfer of air between the air reserve and the inflatable pouch during the phases of contraction of the muscles of the limb (FIG. 5A) and of relaxation of the muscles of the limb (FIG. 5B),

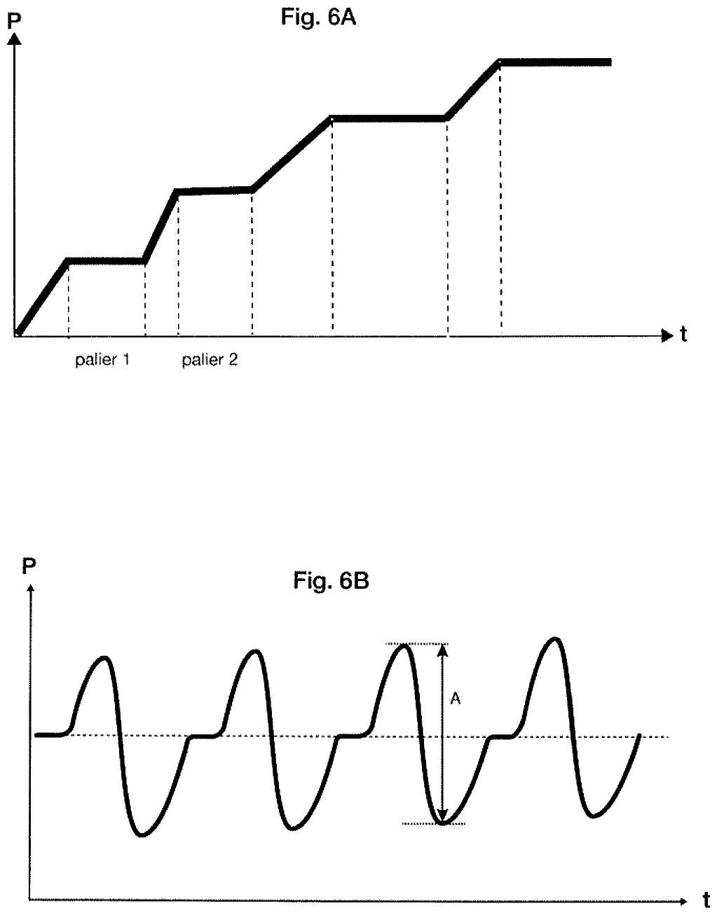

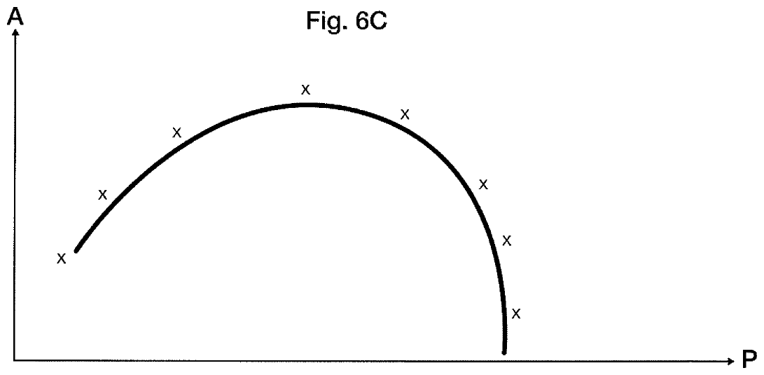

FIGS. 6A to 6C show, in the form of curves, the steps necessary for determining the working pressure as a function of the occlusion pressure of the venous system, in particular the venous return,

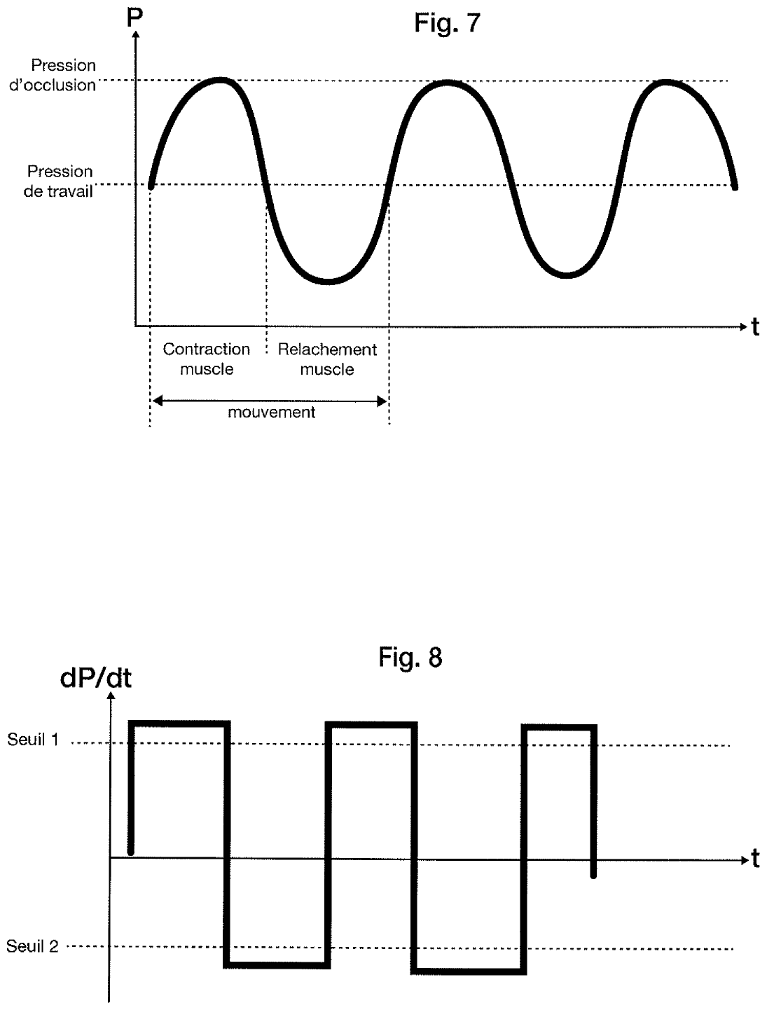

FIGS. 7 and 8 show the curves suitable for calculating the number of movements made during muscular exercise,

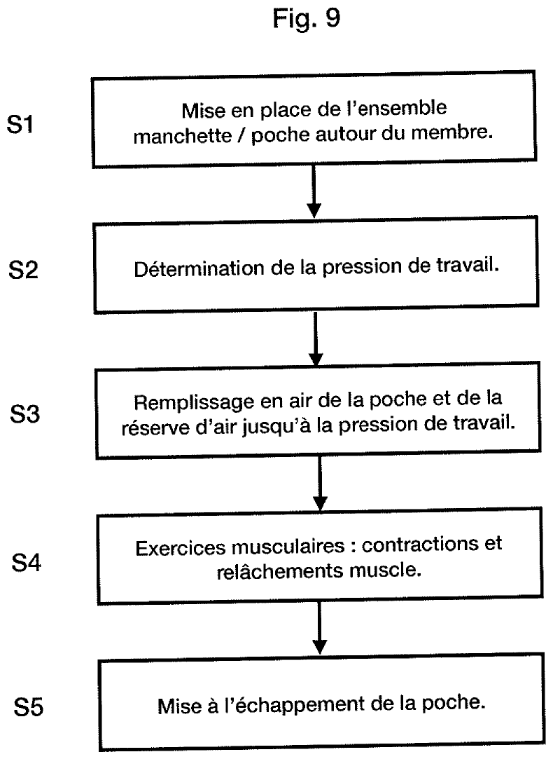

FIG. 9 shows, in the form of a flow diagram, the steps for using an apparatus according to the invention, and

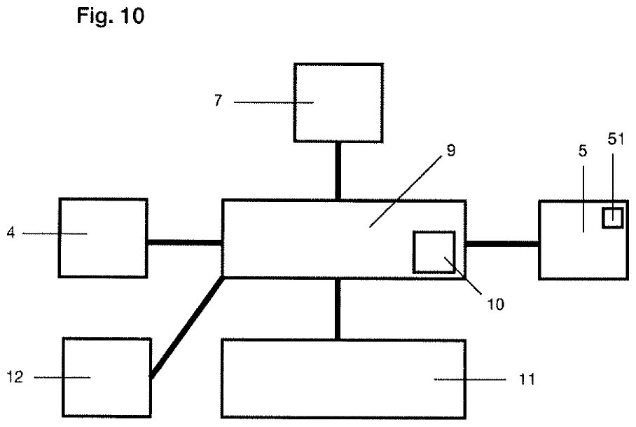

FIG. 10 shows a partial schematic view of an apparatus according to the invention.

### DESCRIPTION

As mentioned above, the invention relates to a physical training apparatus 1 for training or developing the muscle mass of the limbs, such as the lower or upper limbs of a living being. This apparatus 1 thus comprises, as illustrated in FIG. 1, at least one cuff 2 comprising an inflatable pouch 3. The apparatus 1 may equally comprise several cuff/pouch assemblies in order to be able to simultaneously train several limbs, each assembly composed of cuff and inflatable pouch being independent. Each cuff 2 forms, with the inflatable pouch 3, an armband when it is intended for an upper limb, or a thigh band when it is intended for a lower limb. This assembly composed of cuff and inflatable pouch can be of the same type as the armbands used for blood pressure measurement devices on the market and will therefore not be described in detail. The cuff 2 can be in the form of a strip of non-extensible fabric equipped with a hook-and-loop closure system. The assembly composed of cuff 2 and inflatable pouch 3 is positionable around the limb 40 that is to be trained, such that the inflatable pouch 3 is interposed between the cuff 2 and the outer surface of the limb 40, so as to be able, during its inflation, to come to bear on the limb and compress the limb. The cuff 2 is produced from a non-deformable material, in particular a non-extensible material, in order to allow the inflatable pouch 3 to optimally fulfill its function of compressing the limb when in the inflated state. The inflatable pouch 3 can be a pouch that is airtight and elastically deformable, for example a pouch made of rubber.

The apparatus 1 also comprises an inflation device 4 for inflating the pouch 3, which inflation device 4 can be formed by a pneumatic pump or a compressor. This inflation device is intended to supply compressed air to the inflatable pouch 3. Generally, the flow rate of this inflation device is between 0.2 and 5 l/min.

In the example shown, the inflation device is a diaphragm pump.

The apparatus further comprises a control unit 9 configured to control at least the inflation device 4.

Said control unit 9 is in the form of an electronic and computerized system which comprises, for example, a microprocessor and a working memory. According to a particular aspect, the control unit can be in the form of a programmable logic controller.

In other words, the functions and steps described can be implemented in the form of a computer program or via hardware components (e.g. programmable gate arrays). In particular, the functions and steps operated by the control unit or its modules can be carried out by sets of instructions or computer modules implemented in a processor or controller or can be carried out by dedicated electronic components or components of the FPGA type or ASIC type. It is also possible to combine computer parts and electronic parts.

When it is specified that the unit or means or modules of said unit are configured to perform a given operation, this means that the unit comprises computer instructions, and the corresponding means of execution which make it possible to carry out said operation, and/or that the unit comprises corresponding electronic components.

The apparatus also comprises a system 5 for venting the inflatable pouch 3.

In a manner characteristic to the invention, the training apparatus 1 comprises an air reserve 6 independent of the inflatable pouch 3, for an air transfer between the pouch 3 and the air reserve 6. This air transfer takes place at least during a deformation of the pouch which may result from a muscular activity, in particular a relaxation or a contraction of the limb 40 fitted with the cuff 2. The air reserve 6 is offset with respect to the inflatable pouch 3. This air reserve 6 can be made up of one or more elements and can thus be formed by a single chamber or by several chambers communicating with one another. The air reserve 6 and the inflatable pouch 3 communicate in the manner of communicating vessels. This air reserve 6 is connected to the inflatable pouch 3 by a fluidic connection 8 in the form of a flexible conduit. In the example shown, the air reserve 6 is formed by a bottle connected to the inflatable pouch 3 by a flexible conduit. In the examples shown, this air reserve 6 is delimited by a rigid wall. The volume of the air reserve 6 is greater than the volume of the inflatable pouch 3. Ideally, the compression ratio defined by the ratio

P_{B1}/P_{B0} with
P_{B1} corresponding to the pressure of the pouch 4 during the phase of contraction of the muscle of the limb 40 fitted with the cuff and
P_{B0} corresponding to the pressure of the pouch 4 during the resting phase of the muscle of the limb 40 fitted with the cuff
must tend toward 1. This ratio is also equal to

(V_{B0}+V_{R0}/(V_{B1}+V_{R0})

with V_{R0} corresponding to the volume of the reserve 6,
V_{B0} corresponding to the volume of the pouch during the resting phase of the muscle of the limb 40 fitted with the cuff and
V_{B1} corresponding to the volume of the pouch 3 during the phase of contraction of the muscle of the limb 40 fitted with the cuff.

It is thus possible, on the basis of this formula, to optimize the volume chosen for the reserve 6.

The inflation device 4 supplies air to the air reserve 6, which itself communicates with the inflatable pouch 3 via the fluidic connection 8. Thus, the actuation of the inflation device 4 permits filling of the air reserve 6 with air and of the inflatable pouch 3 to the desired pressure.

The connection between the air reserve 6 and the inflatable pouch 3 is not closable, such that a free transfer of air can take place between the air reserve 6 and the inflatable pouch 3 under the effect of a deformation of the pouch. The details of this transfer will be described below.

The training apparatus 1 also comprises a pressure sensor 7 configured to measure the pressure of the air circuit, at least part of which is formed by the fluidic connection 8 between the inflatable pouch 3 and the air reserve 6.

In the examples shown, this pressure sensor 7 is a membrane sensor arranged, at the level of the fluidic connection, between the inflatable pouch 3 and the air reserve 6. Any other type of pressure sensor could have been used in an equivalent manner. The pressure measured by the pressure sensor 7 is, on the one hand, a function of the inflation pressure of the pouch 3 and the compression of the limb which results therefrom, and, on the other hand, a function of the fluctuations of the arterial pulse wave, it being understood that the magnitude of this arterial pulse wave is changed as a function of the inflation pressure. This measured pressure is also a function of whether the limb fitted with the apparatus is in a state of rest or in a state of activity.

As has been mentioned above, the deformation of the inflatable pouch 3 can generate, via the fluidic connection 8, a displacement of air from the pouch toward the air reserve, or vice versa.

FIGS. 3, 4 and 5A, 5B illustrate examples of situations generating such a displacement of air. In FIGS. 3 and 4, the limb fitted with the apparatus is at rest, that is to say does not execute a movement. During the systolic phase of the heart, that is to say during contraction of the left ventricle of the heart, the artery 41 tends to dilate, as is illustrated in FIG. 4, such that the pouch is subjected to compression, and a volume of air resulting from the deformation of the pouch can circulate from the pouch to the air reserve. The reverse phenomenon is observed during the diastolic phase of the heart.

Similarly, when the limb fitted with the cuff is active, that is to say moves from an extended position to a flexed position, the contraction of the muscles, as is shown in FIG. 5A, causes compression of the pouch and therefore a transfer of air from the inflatable pouch 3 to the air reserve 6 via the fluidic connection. Conversely, when the limb moves from the flexed position to an extended position, the relaxation of the muscle by extension, as is shown in FIG. 5B, causes a reduction of the pressure exerted by the limb on the inflatable pouch 3 and, therefore, a transfer of air from the air reserve 6 to the inflatable pouch 3 via the fluidic connection. The pressure variations which result from these different situations can be measured by the pressure sensor 7. This air circuit between inflatable pouch 3 and air reserve can be vented using the venting system 5. This venting system 5 comprises a venting member 51, such as a solenoid valve, arranged on the air reserve 6. This venting can be done manually or automatically. In the examples shown, this venting takes place automatically, and the control unit 9 is configured to control the venting member 51 by controlling the power to the solenoid with which the solenoid valve is equipped. The solenoid valve is thus able to go from the closed position to the open position, return means returning the solenoid valve to the closed position in the unpowered state of the solenoid.

To allow the training apparatus to operate in optimal conditions, it is necessary to define a working pressure setpoint which corresponds to the inflation pressure setpoint of the pouch 3. This working pressure setpoint can be predetermined or calculated. If predetermined, it can be defined using an apparatus other than the one which is the subject of the invention, and it can then be introduced into the apparatus with the aid of a human/machine interface, shown at 12 in the figures. Thus, for example, when the cuff is in the state placed around the limb, the working pressure can be determined with the aid of a pulse oximeter or a vascular Doppler probe.

It can also be calculated, as is the case in the example shown, with the aid of the apparatus itself. Thus, a method for calculating the working pressure is illustrated in FIGS. 6A to 6C. In this case, the assembly composed of cuff and pouch is positioned around the limb that is to be trained. The control unit is configured to control the inflation of the inflatable pouch 3 in stages, in a succession of increasing stages. The pressure values of the stages range here from 100 mmHg to 250 mmHg.

At each pressure stage, the control unit is configured to acquire the pressure signals coming from the pressure sensor 7. These pressure signals allow the establishment of a pressure over time curve, called the pulse wave curve, as is shown in FIG. 6B. On this curve, the value of a characteristic parameter of the curve is determined. The parameter used here is the amplitude of the pulse wave of the curve, and the value used is, for each pressure stage, that of the maximum amplitude. The value of the maximum amplitude A measured at said stage is then associated with the pressure of each pressure stage in order to obtain a curve in accordance with FIG. 6C, representing the pressure on the abscissa, and the maximum amplitude at each pressure stage on the ordinate. A regression of the curve makes it possible to determine the highest pressure at which the amplitude is equal to zero. This pressure is called the occlusion pressure. In the example shown, a local quadratic regression is performed:

A=a×pressure²+b×pressure+c, with a<0.

The occlusion pressure corresponds to the highest pressure for which this regression is canceled. The working pressure is lower than this occlusion pressure and generally corresponds to the occlusion pressure multiplied by a coefficient between 0.5 and 0.8. In the example shown, the coefficient chosen is equal to 80%.

This working pressure, once determined, is stored in a memory 10 of the apparatus and forms the working pressure setpoint. This pressure is necessarily lower than the systolic pressure, that is to say the arterial occlusion pressure of the artery of the limb that is being trained. The control unit is configured to control at least the inflation device and possibly the venting system 5 according to the working pressure setpoint and the data supplied by the pressure sensor 7. In particular, during the phase of physical training, the control unit 9 is configured to maintain the pressure measured by the pressure sensor 7 within a predetermined pressure range containing the working pressure setpoint. Generally, from the working pressure that is calculated, a range of working pressures is defined with values of the range taken below the calculated working pressure and values of the range taken above the calculated working pressure. When the working pressure leaves this range during the phase of physical training, the control unit controls:
the inflation device if the pressure drops to a value below the lower limit of the pressure range, or
the activation of the venting system if the pressure dangerously increases, that is to say leaves the working pressure range by going above the upper limit of the range.

Once the working pressure range has been memorized, the apparatus is ready to operate, so as to allow physical training to be carried out. An operating cycle of the apparatus for carrying out physical training therefore comprises filling the pouch and the associated air reserve with air up to the working pressure setpoint value, maintaining the pouch 3 in the inflated state for a fixed or variable duration, and deflating the pouch 3. These steps are represented as S3, S4 and S5 in FIG. 9, where step S1 corresponds to the placement of the assembly of cuff and inflatable pouch around the arm, and step S2 corresponds to the determination of the working pressure, as has been mentioned above, if the latter has not already been determined by another means. It should be noted that the operating cycle, as described above in steps S3 and S5, can be repeated. In this case, the control unit is configured to control a plurality of operating cycles that are activated sequentially, it being possible for these operating cycles to be identical or different between one operating cycle and another. The duration of inflation of the pouch during an operating cycle can be an adjustable duration chosen by the user and entered into the apparatus via the human/machine interface 12. As a variant, this duration can be fixed and memorized.

It must be noted that the human/machine interface 12 can be formed by a touch screen of a display device 11 of the apparatus or by any other means, such as a keyboard or a remote control or the like. This duration can also be a function of a muscle exercise control program which can be pre-recorded. Thus, in the configuration of use of the apparatus, during the phase of physical training, that is to say in the inflated state of the pouch and with the air reserve filled at a working pressure corresponding to a pressure taken within the predefined working pressure range, the control unit 9 is configured to receive the pressure signals coming from the pressure sensor 7 in order to determine, from the curve of the pressure measured by the pressure sensor as a function of time, the number of muscle relaxations and/or muscle contractions of the limb 40 that is to be trained, so as to compare this number to a predetermined number and to control the deflation of the pouch 3 when the number counted is greater than the number measured. Thus, as is illustrated in FIG. 7, during physical training comprising a succession of movements of the limb, each movement comprising a limb extension phase accompanied by a relaxation of the muscles and a limb flexion phase accompanied by a contraction of the muscles, it is possible to obtain, with the aid of the pressure sensor, the curve P=f(t), as is shown. In the case of regular movements, the pressure wave is a sinusoidal wave, with the upper part of the wave that extends above the working pressure corresponding to the contraction of the muscle, and with the lower part of the wave that extends below the working pressure corresponding to the relaxation of the muscles, that is to say the extension of the limb. This curve is then processed. For this purpose, the curve dP/dt is established, and two threshold values, one positive, called threshold 1, the other negative, called threshold 2, are defined, as well as a reference time period T1. Thus, when dP/dt is greater than the threshold value 1 during a period T1, the part of the movement corresponding to a flexion of the limb is taken into account. When dP/dt is less than the threshold value 2 during a period T1, the part of the movement corresponding to an extension of the limb is taken into account. One flexion and one extension of the limb form one movement. When the calculated number of movements is greater than a predetermined number of movements, the physical training is terminated and the pouch is deflated.

Obviously, other treatments of the curve P=f(t) can be envisioned to improve and quantify the physical training. Similarly, the information relating to the curves obtained can be displayed on a display device 11, which is connected to the apparatus by a wired or wireless link, or on a remote display device, for example a remote terminal, it being possible for this terminal to be formed by a cellphone, a computer screen or similar.

It must be noted that the apparatus can have two operating modes, namely a manual mode and an automatic mode, or just one mode. In the case of an automatic mode, the threshold values, the time period T1, and the number of movements to be performed can be pre-recorded. In a manual mode, this data can be input by the user via the human/machine interface 12. Similarly, the working pressure can be determined in manual mode or in automatic mode. In automatic mode, the move from one pressure stage to another takes place automatically. In practice, in a simplified automatic mode, the user, without having to enter any data, can happily position the assembly of cuff and inflatable pouch around the arm and then let the apparatus automatically determine the working pressure by inflation of the pouch in stages, and then, once this working pressure has been determined, perform his or her physical exercise for a predetermined period, until the automatic deflation of the pouch. Generally, once the working pressure has been determined by the apparatus at the end of the stage-by-stage inflation of the pouch, the pouch is deflated in order to bring the pouch, and obviously the associated air reserve, to the desired working pressure. The training can then begin.

1. An apparatus for the physical training of at least one of the limbs of a living being, said apparatus comprising:
at least one cuff comprising an inflatable pouch, an inflation device for inflating the pouch, a system for venting the inflatable pouch, a control unit configured to control at least the inflation device, said inflatable pouch and the cuff surrounding the pouch being able to be positioned around a limb that is to be trained and being configured to permit, in the inflated state of the pouch, by compression, in particular by constriction, of the limb, a reduction in the blood flow through said limb by at least partial occlusion of the blood circulation system,
wherein the training apparatus comprises an air reserve connected to the inflatable pouch by a fluidic connection for a transfer of air between the pouch and the air reserve at least upon a deformation of the pouch resulting from a muscle activity, in particular a relaxation or a contraction of the limb fitted with the cuff, and a pressure sensor configured to measure the pressure of the air circuit, at least part of which is formed by the fluidic connection between the inflatable pouch and the air reserve.

2. The apparatus for physical training as claimed in claim 1, wherein the venting system comprises a member for venting the inflatable pouch, said member preferably being arranged on the air reserve, and in that the control unit is configured to control the member for venting the inflatable pouch.

3. The apparatus for physical training as claimed in claim 1, wherein the pressure sensor is arranged at the level of the fluidic connection between the inflatable pouch and the air reserve.

4. The apparatus for physical training as claimed in claim 1, wherein the fluidic connection between the air reserve and the inflatable pouch is formed by a flexible conduit, and in that the pressure sensor is preferably a membrane sensor.

5. The apparatus for physical training as claimed in claim 1, wherein the volume of the air reserve is greater than the volume of the inflatable pouch.

6. The apparatus for physical training as claimed in claim 1, wherein the apparatus comprises a memory for memorizing at least one pressure setpoint called the working pressure, corresponding to a pressure below the systolic pressure or arterial occlusion pressure of the artery surrounded by the limb, and in that the control unit is configured to control at least the inflation device and the venting system according to the working pressure setpoint and the data supplied by the pressure sensor.

7. The apparatus for physical training as claimed in claim 6, wherein the control unit is configured, in the configuration of use of the apparatus for physical training, to maintain the pressure measured by the pressure sensor within a predetermined pressure range containing the working pressure setpoint.

8. The apparatus for physical training as claimed in claim 6, wherein the control unit is configured to control the inflation device according to an operating protocol comprising an operating cycle or a plurality of operating cycles that are activated sequentially, each operating cycle comprising filling the pouch and the air reserve with air up to the working pressure setpoint value, maintaining the pouch in the inflated state for a fixed or variable duration, and deflating the pouch.

9. The apparatus for physical training as claimed in claim 6, characterized in that, in the inflated state of the pouch, the control unit is configured to receive the pressure signals coming from the pressure sensor, to determine from the pressure curve, measured by the pressure sensor as a function of time, the number of muscle relaxations and/or muscle contractions of the muscle of the limb that is to be trained, to compare this number to a predetermined number, and to control the deflation of the pouch when the number counted is greater than the number measured.

10. The apparatus for physical training as claimed in claim 6, wherein the working pressure setpoint is a calculated setpoint, and in that the control unit is configured to
control the inflation of the inflatable pouch in stages,
acquire, at each pressure stage, the pressure signals coming from the pressure sensor,
determine, for each pressure stage, the value of a characteristic parameter of the pressure curve as a function time, called the pulse wave curve,
and determine the value of the working pressure setpoint as a function of the values of said parameters.

11. The apparatus for physical training as claimed in claim 1, wherein the inflation device comprises a pump or a compressor.

12. The apparatus for physical training as claimed in claim 1, wherein the inflation device is coupled to the air reserve in order to supply air to the air reserve, which itself communicates with the inflatable pouch via the fluidic connection.
